(19) United States
(12) Patent Application Publication
(10) Pub. No.: US 2004/0199933 A1
(43) Pub. Date: Oct. 7, 2004

(54) System and method for volume equalization in channel receivable in a settop box adapted for use with television

(76) Inventor: Michael Ficco, Silver Spring, MD (US)

Correspondence Address: Hughes Electronics Corporation, Patent Docket Administration, Bldg. 1, Mail Stop A109, P.O. Box 956, El Segundo, CA, 90245-0956, US

(21) Appl. No.: 10/407,329

(22) Filed: Apr. 4, 2003

(51) Int. Cl. H04N 7/16

(52) U.S. Cl. 725/151; 725/139

(57) ABSTRACT

A system and method are disclosed for maintaining a consistent volume level as the user changes channels in a settop box adopted for use in a television system, wherein the steps comprise selecting a reference channel and adjusting the gain of a pre-amp so that the mean output level of the pre-amp remains the same on the new channel. The system and method also provides for allowing multiple users to specify unique channel volume configurations for one, some or all the channel receivable by a settop box, and for dynamically adjusting audio amplification to maintain the output audio in an acceptable range.

### FIELD OF THE INVENTION

This invention relates to settop boxes for television systems. More particularly, the invention relates to a system and method for controlling the volume to a preset level under various television viewing scenarios.

### BACKGROUND OF THE INVENTION

As is known, conventional communications systems typically include a receiver for receiving and processing transmitted waveforms. For example, in a satellite communications system, the receiver can include a small satellite dish connected by a cable to a settop box (STB) or an integrated receiver-decoder (IRD), which are used as interchangeable terms in the art. The satellite dish is aimed toward the satellites, and the STB is connected to the user's television in a similar fashion to a conventional cable-TV decoder.

A micro-controller controls the overall operation of the STB, including the selection of parameters, the set-up and control components, channel selection, viewer access to different programming packages, blocking of certain channels, and many other functions. The compression and decompression of packetized video signals can be accomplished according to the standards established by the Motion Picture Expert Group (MPEG) or other known standards. Likewise, the compression and decompression of audio signals can be accomplished according to the MPEG standards, DOLBY DIGITAL (or AC-3) standards, DTS or other known standards. The conventional STB also typically includes video and audio decoders in order to decompress the received compressed video and audio. The STB can output video and audio data to a number of destinations, including audio and video decoders, ports, memories, and interface devices, such as a digital VHS (DVHS) interface. The STB can send the same audio and video data to different destinations. Conceivably, this can be in the form of commands to control a variety of peripherally connected devices.

Recently, due to the advances in digital technology and with a goal of creating greater personalization and customization for viewers, the STB has become embodied as part of a digital audio/video recording device or system. These devices incorporate a host of both traditional and powerful new features and functionality. For example, these features can include high quality digital audio/video (A/V), the ability to pause/rewind live video and/or audio programs as they are broadcast, multi-speed fast forward and fast rewind, instant replay, slow motion and frame by frame advance. Additionally, the viewer can have access to, and have the ability to manipulate or develop, an electronic program guide of listings.

Such digital video recording devices allow sports fans and movie buffs alike to have full control of live television programs and sporting events in full digital-quality. Viewers can also be able to create customized programming by searching for, and recording, programs that match their preferences by actor, director, keyword or any combination of content searches. Combined with the wide variety of program selections, viewers can find exactly what they are looking for and even create their own “TV channels” based on their favorite programming.

The electronic program guides generally can be displayed as a menu on a screen of a TV for example. Operation of push buttons on the STB or keys of a remote control can display a series of menu screens having an array of cells corresponding to particular programming events, channels, TV programs, etc. The viewer can scroll through the cells to choose a particular program, pull up another sub menu to find out more information on a particular program, or pull up a sub menu with additional options.

FIG. 2 is an exemplary arrangement of STB 100 within a direct broadcast satellite or digital video broadcast (DVB) system to illustrate the STB 100 in its typical environment. In FIG. 2, the system 200 can comprise a transmit antenna station (hereinafter referred to as uplink facility 210 for clarity), satellite 220, receive antenna 250, and STB 100.

The transmit antenna station can be a DIRECTV® satellite uplink facility, for example, or any other earth station as described above and which is well known in the art. The bitstream or airlink 205 is a suitable content signal such as a digital audio and video television data signal (A/V signal), the medium is a satellite 220, and the receive antenna 250 is preferably an outdoor unit (ODU). As illustrated in FIG. 2, the ODU is connected to STB 100 via coaxial cable 275.

STB 100 can also be connected to a display 170, such as a standard definition television, a high definition television or a PC monitor, and also can be connected to a telephone line 270. STB 100 can be controlled via a remote control 216 as is well known in art, using known RF, IR, and acoustical transmission and reception techniques.

The user command interface in the present invention however is not limited to a remote control device. Alternatively, any of function buttons residing on the STB, a keyboard or mouse operatively connected thereto and/or connected to a PC that is in communication with the STB, USB ports, voice-activation software devices within or operatively connected to the STB, or command and/or instructions by remote call-in using DTMF (Dual Tone Multi-frequency) tones for example, can be substituted as the user command interface to the STB, and/or to control designated functions relating to the selection and generation of scripts and/or program content routines, as will be explained in detail hereinafter.

FIG. 1 illustrates an exemplary architecture of the STB 100. STB 100 constitutes a relatively high-end settop capable of digital recording (via HDD 120) and high quality graphics (via graphics accelerator 160). Of course, the teachings of this invention can also be implemented on much more basic devices. The STB 100 utilizes a bus 105 to interconnect various components and to provide a pathway for data and control signals. FIG. 1 illustrates a host processor 110, a memory device 115 (in an exemplary configuration embodied as an SDRAM 115) and a hard disc drive (HDD) 120 connected to the bus 105. In this embodiment, the host processor 110 can also have a direct connection to SDRAM 115 as shown in FIG. I (i.e., such that SDRAM 115 is associated as the memory for host processor 110). Although memory device 115 is described as SDRAM 115 hereinafter in the present application, memory devices of EDODRAM (extended data output DRAM), BEDO RAM (Burst EDO RAM), RLDRAM by Rambus, Inc., SLDRAM by the SyncLink Consortium, VRAM (video RAM), or any other known or developing memory that is write-able can be sufficient as memory device 115.

As further shown in FIG. 1, a transport processor 130 and PCI I/F 140 (Peripheral Component Interconnect interface) are connected to the bus 105. The transport processor 130 also has a connection to input port 125 and SDRAM 135. SDRAM 135 has the same attributes as SDRAM 115 and can be replaced with any of the other above-noted alternative memory devices. Furthermore, the PCI I/F 140 is connected to a decoder 150. The decoder 150 is connected to a graphics accelerator (GA) 160. The output of GA 160 is in turn sent to a display device 170. Decoder 150 can include both an MPEG audio/video (A/V) decoder 152 and an AC-3/MPEG audio decoder 156, the output of the latter being sent to display device 170 after conversion in a digital-to-analog converter (DAC) 172.

FIG. 1 presents a view of the internal workings of a digital settop device where the transport processor 130 and host processor 110 are different devices (“different” can mean physically separate, or functionally different, though one physical unit). This can be a physical or a philosophical split. The host processor 110 can generally be viewed as responsible for interacting with the human operator. Such interaction can be receiving and responding to commands and presenting and managing a user interface or graphic user interface (GUI). In this view, transport processor 130 performs the real-time functions such as control of the A/V data flow, management of conditional access, etc. The details related to the distinction between and responsibilities of the host and transport processors 130 and 110 are at the discretion of the settop designers. At times, all functions can even be deemed the responsibility of a single high-powered ASIC (Application Specific Integrated Circuit). Such an ASIC can integrate system peripherals such as interrupt controllers, timers, and memory controllers (including ROM, SDRAM), DMA controllers, a packet processor, crypto-logic, PCI compliant PC port, and parallel inputs and outputs, etc. Similarly, FIG. 1 shows the SDRAM 135 as being separate from the transport processor 130, it being understood that the SDRAM 135 can be dispensed with altogether, consolidated with SDRAM 115, or even located inside the aforementioned ASIC.

HDD 120 is actually a specific example of a mass storage device, and can be replaced with other mass storage devices, as is generally known in the art. These include, for example, magnetic and/or optical storage devices, (i.e., embodied as RAM, a recordable CD, a flash card, memory stick, etc.). Of course, the greater storage capacity of HDD 120, the greater the number of movies and multimedia that can be stored.

The bus 105 can be implemented with conventional bus architectures such as a peripheral component interconnect (PCI) bus that is standard in many computer architectures. Alternative bus architectures such as VMEBUS from Motorola, NUBUS, address data bus, RAM bus, DDR (double data rate) bus, etc., could of course be utilized to implement bus 105.

Input port 125 receives audiovisual bit-streams that can include, for example, MPEG-1 and MPEG-2 video bit-streams, MPEG-1 layer II audio bit-streams and DOLBY DIGITAL (AC-3) audio bit-streams. Exemplary A/V bit-rates can range from about 60 Kbps to 15 Mbps for MPEG video, from about 56-384 Kbps for MPEG audio, and between about 32-640 Kbps for AC-3 audio. The single-stream maximum bit-rate for STB 100 can correspond to the maximum bit-rate of the input programming, for example, 16 Mbps or 2 Mbps, which corresponds to the maximum MPEG-2 video bit-rate of 15 Mbps, maximum MPEG-1 Layer-2 audio bit-rate of 384 Kbps, and maximum AC-3 bit-rate of 640 Kbps.

Any audio or video formats known to one of ordinary skill in the art could be utilized. Although FIG. 1 has been described in conjunction with digital television, the signal supplied can be any type of television signal, any type of audio or video data, including, of course, analog voice data over a telephone line, or any downloadable digital information. Of course, various other audiovisual bitstream formats and encoding techniques can be utilized in recording. For example, STB 100 can record an AC-3 bitstream, if AC-3 broadcast is present, along with MPEG-1 digital audio. Still further, the received audiovisual data can be encrypted and encoded or not encrypted and encoded. If the audiovisual data input via the input port 125 to the transport processor 130 is encrypted, then the transport processor 130 can perform decryption. Moreover, the host processor 110 can perform the decryption instead.

The PCI I/F 140 can be constructed with an ASIC that controls data reads from memory. Audiovisual (A/V) data can be sent to the host processor 110's memory (SDRAM 115) while simultaneously being sent to an MPEG A/V decoder 152, as further discussed below.

Decoder 150 can be constructed as shown in FIG. 1 by including the MPEG A/V decoder 152 connected to the PCI I/F 140, as well as an AC-3/MPEG audio decoder 156 that are also connected to the PCI I/F 140. In this way, decoders 152 and 156 can separately decode the video and audio bitstreams from the PCI I/F 140, respectively. Alternatively, a consolidated decoder can be utilized that decodes both video and audio bitstreams together. The encoding techniques are not limited to MPEG and AC-3, of course, and can include any known or future developed encoding technique. In a corresponding manner, the decoder 150 could be constructed to process the selected encoding technique(s) utilized by the particular implementation desired.

In order to more efficiently decode the MPEG bitstream, the MPEG A/V decoder 152 can also include a memory device such as SDRAM 154 connected thereto. This SDRAM 154 can be eliminated, consolidated with decoder 152 or consolidated with the other SDRAMs 115 and/or 135. SDRAM 154 has the same attributes as SDRAM 115 and 135, and can be replaced with any of the other above-noted alternative memory devices.

A graphics accelerator (GA) 160 includes processing circuitry for performing graphics processing of a decoded input video stream, and encoding circuitry for encoding and converting the processed video to analog prior to outputting it to display device 170. GA 160 also includes a memory interface that communicates with an SDRAM 162 in order to direct the incoming video bit stream to a specific storage location in SDRAM 162, and also selects the frames and frame order for display.

Display device 170 can be an analog or digital output device capable of handling a digital, decoded output from the GA 160. If analog output device(s) are desired, to listen to the output of the AC-3/MPEG audio decoder 156, a digital-to-analog converter (DAC) 172 is connected to the decoder 150. The output from DAC 172 is an analog sound output to display device 170, which can be a conventional television, computer monitor screen, portable display device or other display devices that are known and used in the art. If the output of the AC-3/MPEG audio decoder 156 is to be decoded by an external audio component, a digital audio output interface (not shown) can be included between the AC-3/MPEG audio decoder 156 and display device 170. The interface can be a standard interface known in the art such as a SPDIF audio output interface, for example, and can be used with, or in place of DAC 172, depending on whether the output devices are analog and/or digital display devices.

The video output from GA 160 and/or audio output from audio decoder 156 or DAC 172 does not necessarily have to be sent to display device 170. Alternatively, encoded A/V data can be output to external devices or systems operatively connected to the STB 100, such an off-broadcast system, cable TV system or other known systems that can reproduce the encoded audio and/or video signals for reproduction and/or display. This can also include a PC that can play video or audio files containing the encoded A/V data sent from the STB 100, for example. In such an embodiment, text or voice files could be sent from the STB 100 to the PC in the form of an e-mail message with text or sound file as an attachment thereto, as will be explained in more detail hereinafter.

The discussion thus far has relied principally on the example of satellite settop boxes. However, the problems solved by the teachings of this invention apply to all types of settop boxes including, but not limited to, cable-television (CATV) systems, home stereo/video playback systems (for both video playback and any audio playback (radio, tape, CD, DVD, MP3 and similar devices)), “normal” TV systems (i.e., TV receiving broadcasts via TV set or rooftop aerial) or any other audio/video playback system. Thus, any reference to STB 100, and in particular to problems in prior art STBs 100 includes reference to settop boxes of these aforementioned devices.

However, as complete as STB 100 has been shown to be, what is lacking is an ability to maintain the volume of the audio portion of the received program at a consistent level as the viewer switches to a new channel. Even casual TV viewers will have noticed that (for whatever reason) different stations maintain vastly different “typical” volume levels. Switching between two football games, for example, can require constantly readjusting the TV volume to accommodate the different native audio levels used by the two channels. The teachings of this invention describe a heretofore unknown method of maintaining a consistent output at the level desired by the user.

### SUMMARY OF THE INVENTION

It is therefore a general object of the invention to provide a settop box that will obviate or minimize significant changes in volume as new channels are selected for viewing.

The above described disadvantages are overcome and a number of advantages are realized by the present invention which relates to a system and method for setting a unique amplification level for each channel received by the settop box adopted for use in a television system. As delivered from the factory, every channel of a settop box has the same (default) amplification. Hence, the out of box performance would be identical to that of a settop lacking the advantages realized by this invention. It could also be that experience would teach that some channels are inherently lower volume and at the time of manufacture could be boosted in a predetermined fashion using this invention.

In the present invention, whenever a channel is tuned, the correct amplification level is set in the pre-amp as part of the tuning process. An example implementation of this is to associate an amplification level with every channel entry in a program guide used by the settop. When the channel is tuned, information is read from the program guide and used in performing the tuning operation. Additionally, the amplification level associated with the channel is read from the program guide and written to the pre-amp controller so as to compensate for any inherent difference between channels.

An objective of this invention can be realized when combined with a user interface that allows the TV viewer to configure channel volumes as desired. Hence, there is a user interface related to this invention that allows the user to select a reference channel against which other channel volumes will be compared. In one implementation, level comparisons of this invention are done at the output of the pre-amp. Additionally, the compared levels are mean levels, not instantaneous levels.

The present invention, when combined with a suitable user interface, further provides a system and method for equalizing the audio volume of the current channel to that of the previously established reference channel.

There is also a user interface that allows the pre-amp level of the current channel to be increased or decreased over its current setting. Such an increase or decrease can be temporary (not used the next time that channel is accessed) or permanent. Of course, additional user interface capabilities can be associated with this embodiment of the invention.

The present invention additionally provides a system and method for equalizing audio levels for all channels receivable by a settop box adapted for use with a television system. When commanded by the user, the settop will automatically iterate through all channels for which the user is authorized and adjust the gain of the pre-amp to achieve a level substantially equal to the level of the reference channel. The pre-amp values of each channel are stored for use when that channel is accessed in the future.

The present invention also provides a system and method for maintaining the volume level of the currently tuned channel within a range deemed acceptable by the user. For each channel receivable by a settop box adapted for use with a television system, the present invention specifies an amplification value for the pre-amp, and minimum and maximum pre-amp output values. A suitable user interface allows the user to influence these minimum and maximum levels. The amplification (gain) value of the pre-amp is responsible for establishing the mean output level. However, the pre-amp output level can instantaneously exceed the specified maximum as the audio level of the program varies. At such times the pre-amp gain is reduced to avoid an output louder than the loudest desired by the user. Likewise, soft passages of the program can have an output that falls below the desired minimum. At such times the pre-amp gain is boosted to help maintain a minimum volume level. Of course, maximum boost would be capped to accommodate true silence in the program.

### BRIEF DESCRIPTION OF THE DRAWINGS

The novel features and advantages of the present invention will best be understood by reference to the detailed description of the preferred embodiments which follows, when read in conjunction with the accompanying drawings, in which:

FIG. 1 illustrates an exemplary architecture of a settop box;

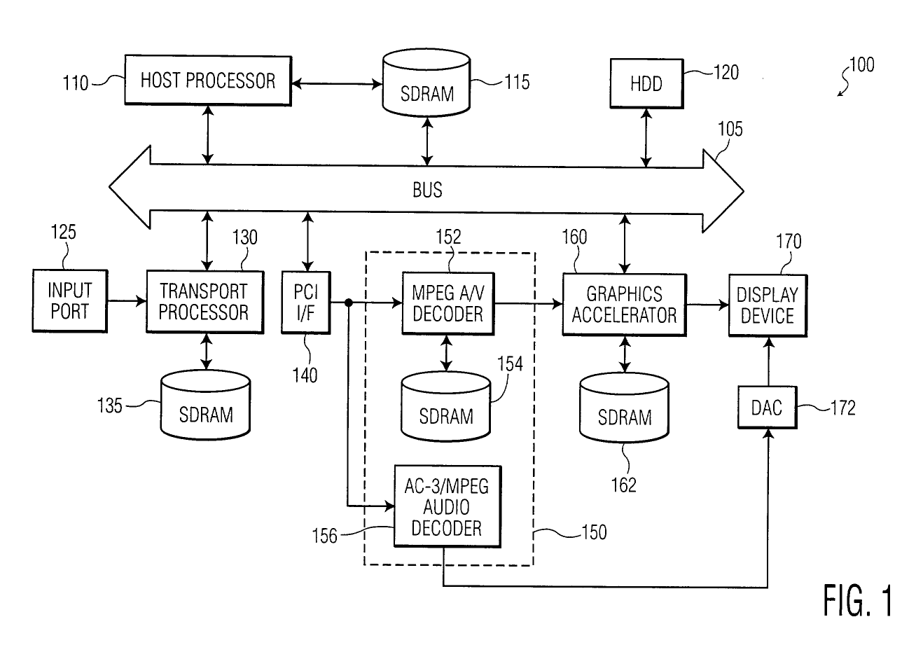

FIG. 2 illustrates an arrangement of settop box within a direct broadcast satellite or digital video broadcast system;

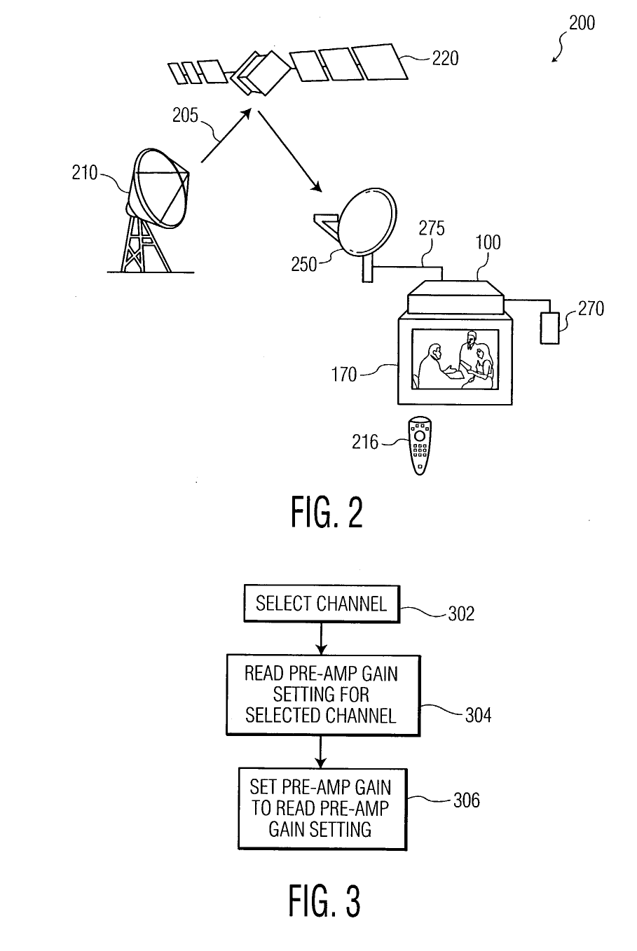

FIG. 3 illustrates a flow diagram of a general method for setting a volume level for a television channel in accordance with an embodiment of the invention;

FIG. 4 illustrates a block diagram of a pre-amp circuit for controlling an audio level in a settop box in accordance with an embodiment of the invention;

FIG. 5 illustrates a flow diagram of a method for establishing a volume setting in accordance with an embodiment of the invention;

FIGS. 6 and 7 illustrate a flow diagram of a method for establishing a specific volume setting for all channels in a television system in accordance with an embodiment of the invention;

FIG. 8 illustrates a flow diagram of a method for maintaining a specific volume range during a viewing session regardless of channel or program changes in accordance with an embodiment of the invention; and

FIGS. 9A and 9B illustrate a graphical relationship of audio sound levels versus time during channel or program changes without, and in accordance with, an embodiment of the invention.

### DETAILED DESCRIPTION OF THE PREFERRED EMBODIMENTS

The various features of the preferred embodiments will now be described with reference to the drawing figures, in which like parts are identified with the same reference characters. The following description of the presently contemplated best mode of practicing the invention is not to be taken in a limiting sense, but is provided merely for the purpose of describing the general principles of the invention.

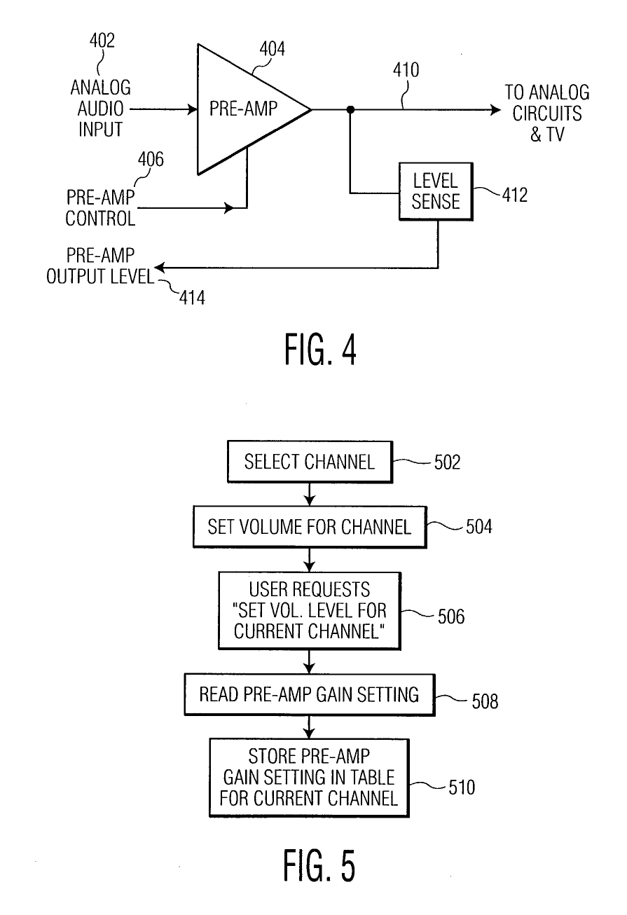

FIG. 3 illustrates a flow diagram of a general method for setting a volume level for a television channel in accordance with an embodiment of the invention. The method of FIG. 3 begins with step 302. In step 302, a user selects a channel for viewing. This can be accomplished by use of a user interface. The user interface can be a remote control device, or it can be the settop box itself, manipulated through the use of buttons and an on-screen menu. Both of these interfaces are well known to those skilled in the art of the invention, and further description is not necessary. Before proceeding to discussion of the remaining steps of the method of FIG. 3, operation of a typical pre-amp circuit will be described in order to assist in understanding of the remaining steps of the method shown in FIG. 3, and other methods discussed below.

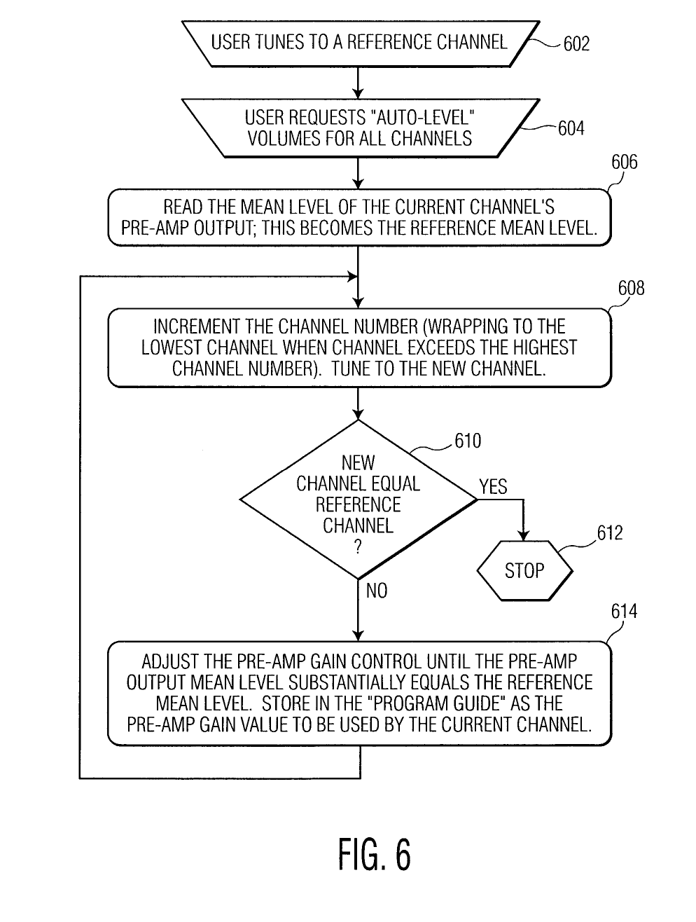

FIG. 4 illustrates a block diagram of a pre-amp circuit for controlling an audio level in a settop box in accordance with an embodiment of the invention. Other types of circuits, for example, digital circuits, can be used as well. In FIG. 4 analog audio is obtained from the received signal which contains an inherent level of audio signal. The inherent level of the audio signal is dependent on how the provider of the signal (i.e., the channel's production set), forms the audio and video signal. The inherent level of the audio signal can vary from channel to channel, and from different portions of the program even if amplification was equal between all channels. The analog audio signal 402 is input into a pre-amp 404. The pre-amp 404 has a gain control input, pre-amp control 406, which is a software controlled signal, generated by the microprocessor (processor) 110 within STB 100. In the preferred embodiment of the invention, the pre-amp control 406 is a digital value that specifies the percentage of the amplifier's gain to be used. For example, if the pre-amp was capable of a maximum amplification of twenty, setting a gain value of 50% would result in the output signal 410 of the pre-amp 404 ten times greater than input 402. If the pre-amp control was an 8 bit value (for a range of 0 to 255), 50% would be indicated by writing a value of 128.

In a typical operating scenario, the pre-amp gain control is nominally set at 50%, resulting in the pre-amp operating at about half its maximum amplification. Low volume channels can have the gain set at, for example, 70%, to obtain a volume generally equal to the typical channel. High volume channels can have the gain control set at, for example, 40%, and can be reduced even further during annoyingly loud commercials.

The pre-amp audio output 410 is then directed to other circuitry, which in most instances is an amplifier, and/or filter(s), the output of which is an analog audio signal output to the television's speakers. Another element in the pre-amp circuitry is a level sense detector 412. The level sense detector 412 provides feedback information to the processor 110 in the STB 100 in the form of instantaneous and time averaged sense of the adjusted level output from the pre-amp. The averaging time can be set manually or automatically, but has a pre-programmed value to be used, at least initially. The output of the level sense detector 412, pre-amp output level 414, is useful in various alternative embodiments of the invention. In an alternate implementation, the level sense hardware provides only instantaneous output levels and the microprocessor software does the averaging.

Referring back to FIG. 3, in step 304 the settop box reads the pre-amp gain setting for the channel stored in the pre-amp gain table. An example of the pre-amp gain table is shown below, in Table I:

TABLE I

| | Pre-Amp | Gain-Value |
|---|---|---|
| Channel No. | Gain Setting (%) | (Hexadecimal) |
| 1 | 85 | D9 |
| 2 | 88 | E0 |
| 3 | 64 | A3 |
| 4 | 48 | 7A |
| 5 | 50 | 80 |
| 6 | 50 | 80 |
| 7 | 50 | 80 |
| 8 | 72 | B8 |
| 9 | 50 | 80 |
| 10 | 40 | 66 |
| . | . | . |
| . | . | . |
| . | . | . |
| 199 | 50 | 80 |
| 200 | 41 | 69 |

In Table I, the pre-amp gain table, there are three columns: The first is labeled “channel no.”, the second is “pre-amp gain setting” and the third is “gain value”. In this example “pre-amp gain setting” is in units of percentage while “gain value” is the 8 bit binary number written to the pre-amp gain control port by the processor 110 that corresponds to the desired percentage of the pre-amp's maximum amplification. Of course, a pre-amp gain percentage of zero mutes the audio.

Reffering back to Table I, it can be seen that channels 5-7, 9, and 199 have the default pre-amp gain settings. Channels 1-3 and 8 have gain values above 50% and therefore correspond to channels whose intrinsic volumes are lower than the typical channel. Channels 4, 10, and 200, however, have gain values below 50% and correspond to channels that are intrinsically loud. Different embodiments of the invention can set the volume for the channels by various methods, but, in each instance, the pre-amp gain setting for each channel is maintained in some form of table that associates a gain setting with each channel. In a preferred embodiment, this “column” of values is added to the already existing program guide. The minimum and maximum pre-amp output level 414 values, used in “active volume equalization,” discussed in detail below, can also be stored in a modified program guide.

Although the discussion of FIG. 4 has been made in an analog signal environment, one skilled in the art can appreciate that identical operations to an audio signal can be made if the audio signal is in a digital format. In this case, all the aforementioned operations of amplification and control of the output level can be performed digitally. In this embodiment, the digital audio signal is read as data and an algorithm is performed in a processor which determines its inherent value, and then adjusts it (through well known digital signal processing techniques) to obtain the preferred output level. The processing of the audio signal in either a digital or analog format is transparent to the user of the settop box level equalizer system.

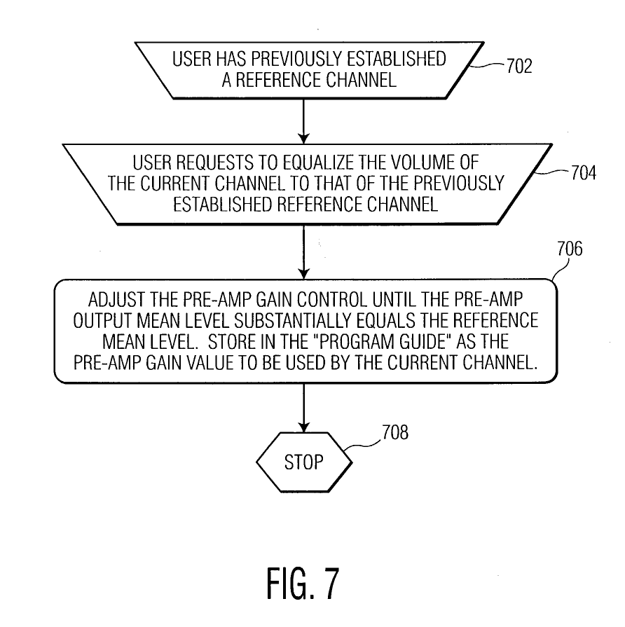

FIG. 5 illustrates a flow diagram of a method for establishing a volume setting in accordance with an embodiment of the invention. In the method illustrated in FIG. 5, the user can specify the relative mean volume level of the current channel. FIG. 5 begins with step 502 in which the user selects a channel for viewing. In step 504, by means of a suitable interface, the user increases or decreases the pre-amp gain until the desired volume is achieved. In step 506, the user requests “set volume level for current channel” on the user interface. In step 508 the STB 100 processor 110 reads the pre-amp gain control setting and in step 510 it is stored in the pre-amp gain table. This interface action would preferably consist of pressing a button on a remote or manipulating controls on the STB 100 equalizer itself in which the STB 100 equalizer understands the instructions to read the current pre-amp gain value and then store this gain value into the pre-amp gain table as a pre-amp gain setting for this particular channel. Thereafter, if, for example, several days pass and the user returns to this channel, it will automatically set the pre-amp gain to the value found in the pre-amp gain table.

In an alternative embodiment of the invention in accordance with the method presented in FIG. 5, different users of the STB 100 can establish a pre-amp gain setting for a current channel based on their own preferences. In this case, step 506 is modified to reflect the possibility that more than one user can establish a pre-amp gain setting for a channel. Step 506 then reads “user requests ‘set volume for current channel for user A’”. There is no theoretical limit to the number of users that can be accommodated in this fashion; the only practical limits are those related to memory and processing capacity.

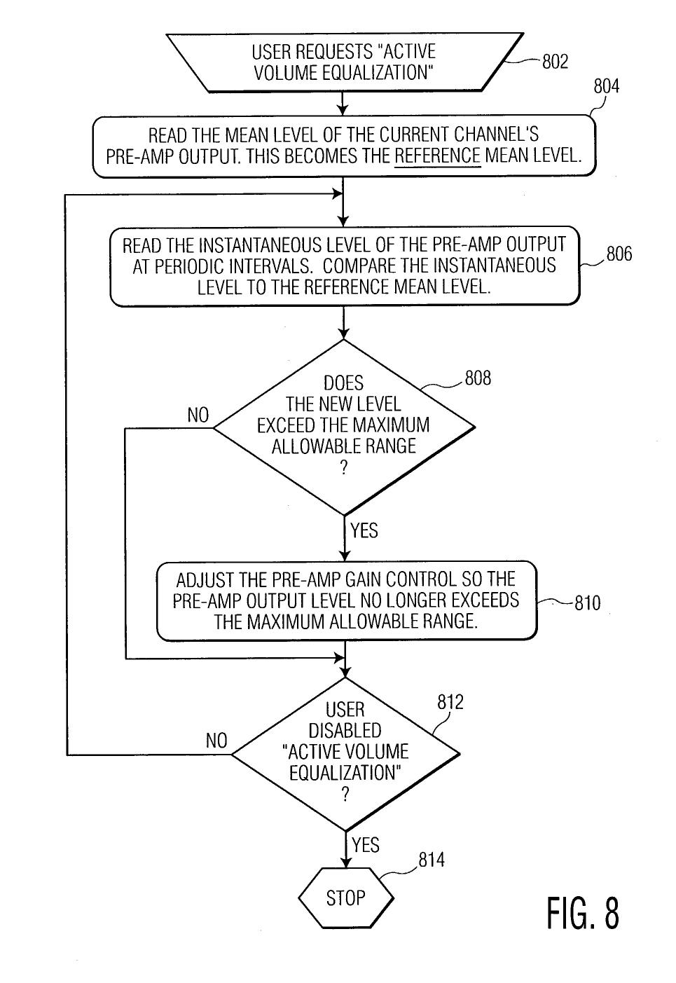

FIG. 6 illustrates a flow diagram of a method for establishing a specific volume setting for all channels in a television system in accordance with an embodiment of the invention. FIG. 6 illustrates the steps for automatic leveling for all channels in the settop equalizer. As mentioned above, the settop equalizer is able to process a large number of channels. In this embodiment of the invention, the settop equalizer would enter a gain value in the pre-amp level table for each channel that resulted in a mean output level that is substantially equal to the mean output level for a particular “reference” channel. The pre-amp gain will be adjusted such that the mean output level of each channel substantially equals that of the mean output level of the reference channel. The pre-amp gain used will be individually stored for each channel in the pre-amp gain table.

The method of FIG. 6 begins with step 602 in which the user selects a “reference” channel to which the others will be compared. In step 604 the user then interfaces with the STB 100 equalizer by requesting “auto-level volumes for all channels”, which begins the process of automatic leveling for all channels. Typically, as above, this would entail depressing a button or otherwise interacting with the user interface of the settop. The STB 100 equalizer then reads the current pre-amp output mean level per step 606.

The pre-amp output mean level is generated by level sense 412. When read in step 606, it becomes a reference mean level. The pre-amp level setting corresponding to this reference channel remains unchanged since it is the reference to which the others will be compared. The STB 100 then increments the channel number (it wraps to the lowest channel number when appropriate) and tunes the settop to the new channel (step 608). If all the channels have been processed, as determined by step 610, the method stops at step 612. In step 614, the settop equalizer measures the mean pre-amp output level of the new channel. If the mean pre-amp output level is lower or higher than the reference mean level, as determined above, it will adjust the gain value until the mean pre-amp output level for the next channel is within a range of tolerance of the reference mean level for the reference channel. The pre-amp gain setting is then stored in the pre-amp gain table. This process continues until the “next” channel wraps back to the reference channel, at which point the method stops.

Note that the actual choice of reference channel is not important. All channels are adjusted relative to what ever channel was chosen as the reference. When done, all channels will have substantially the same volume independent of the actual starting channel. This process can take some time to perform since each channel has to be tuned and the output volume must be sampled for a suitable period of time to establish a mean value.

FIG. 7 is a variant of FIG. 6 wherein only the current channel is equalized to the previously established reference channel.

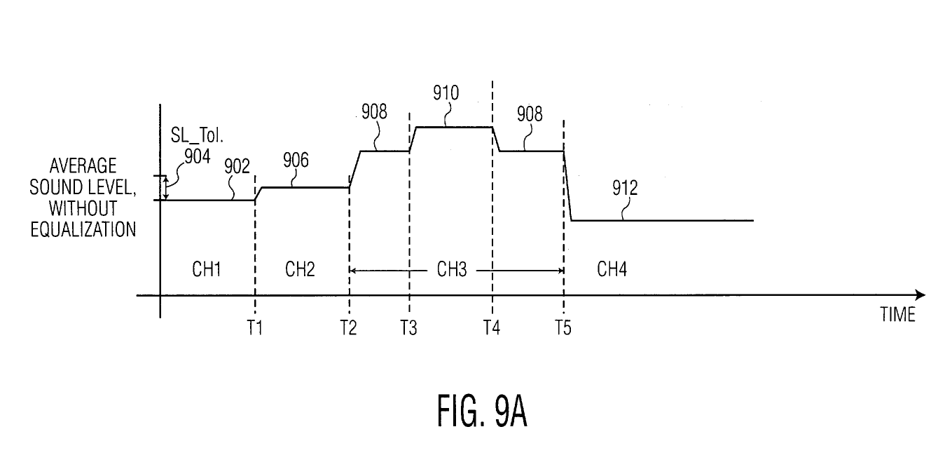

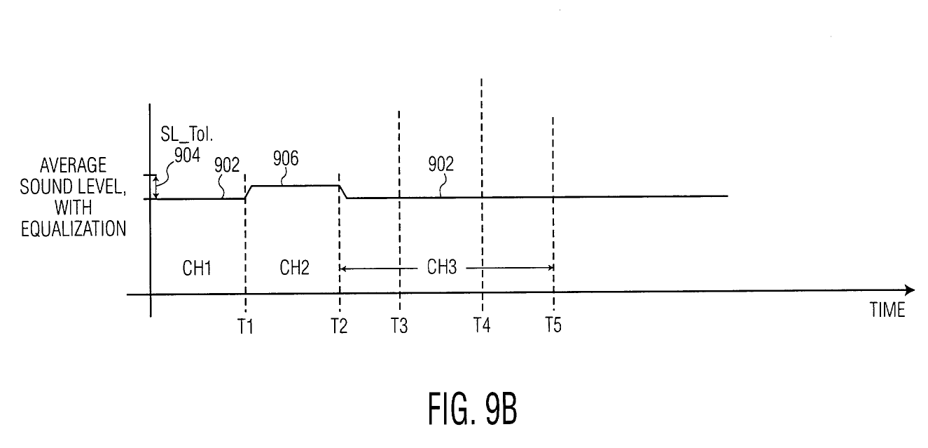

FIG. 8 illustrates a flow diagram of a method for establishing a specific volume setting during a viewing session regardless of channel or program changes in accordance with an embodiment of the invention. In using the method of FIG. 8, the settop maintains the audio in a predetermined range by dynamically adjusting the pre-amp gain in real or near-real time, even when channel changes occur, or there are sudden increases or decreases in channel volume. This method will inhibit all volume changes outside of a specified range. For example, if the user is viewing channel X and determines that channel X is set to an appropriate volume level setting, and then changes to channel Y, channel Y would automatically, in accordance with embodiment of the invention, be set to the volume level setting of channel X. FIGS. 9A and 9B illustrate the difference between the volume output level when the method of FIG. 8 is being implemented and when it is not.

The method as illustrated in FIG. 8 begins with step 802. In step 802 the user requests “active volume equalization” from the interface device, or STB 100 itself. In step 804 the STB 100 equalizer reads the current pre-amp output mean level 414, and this becomes the reference mean level. Thereafter, at regular intervals, the STB 100 equalizer reads the pre-amp output mean level and compares it to the reference mean level (steps 806and 808). If the pre-amp output level is too low or two high, the pre-amp gain is adjusted to compensate (810). This continues until the user turns off “Active Volume Equalization” in step 812.

The “maximum allowable range” used in step 808 can be preset at the factory or, in a slightly different implementation, can be adjusted by the user for each channel.

Note that, in this mode of operation, the pre-amp gain can vary from second to second. Each new value is not written to the pre-amp level table, since this value is being dynamically adjusted to compensate for extreme changes in the content of a program. The value in the pre-amp level table simply serves as a starting point for this dynamically adjusted value.

FIGS. 9A and 9B illustrate a graphical relationship of audio sound levels versus time during channel or program changes without, and in accordance with an embodiment of the invention. FIG. 9A illustrates the relationship between the average sound level without equalization versus time, and FIG. 9B illustrates the relationship between the average sound level with equalization versus time in accordance with an embodiment of the invention. In FIGS. 9A and 9B, SL_Tol 904 represents the tolerance value that is used in step 808 when deciding to change the pre-amp output mean level. In FIG. 9A, there is no equalization being performed in accordance with the method of FIG. 8. As the user watches channel 1 (CH₁), the average sound level is shown as first sound level 902. At time T₁, the user changes the channel to CH₂. The second sound level 906 is only slightly higher than the first sound level, and at time T₂, the channel is changed CH₃. Here, the third sound level 908 is noticeably higher. At some time T₃, the fourth sound level 910 occurs (which lasts until time T₄). Luckily, this sound level does not last too long, and the sound level returns to the third sound level 908. At time T₅, the user changes channel to CH₄, and a noticeable decrease in sound level occurs, to a fifth sound level 912. If no equalization occurred, the user would have to change the volume control each item there was a noticeable and unpleasant difference in the average sound level from the preferred average sound level 902.

In FIG. 9B, equalization occurs according to the method of FIG. 8, in accordance with a preferred embodiment of the invention. In FIG. 9B, all channel changes, volume increases and volume decreases occur at the same time points as in FIG. 9A. However, there is a tremendous difference in listening enjoyment experienced by the user because the average sound levels are all fairly the same. At time T₁, the user changes from CH₁ to CH₂. However, the difference in average sound level between the two channel is less that SL_Tol 904, so no equalization occurs. Thus, there is slight rise in average sound level, to second sound level 906. But, when the user changes to CH₃ at time T₂, the difference between the first sound level (which is the reference mean level referred to in step 804) and the third sound level 908 exceeds SL_Tol 904, thereby evoking an automatic change in the pre-amp gain. The gain is adjusted to force the output 414 to within the maximum allowable range of reference level 902. At time T₃, a sudden increase in sound level occurs again, and this change in magnitude of volume also exceeds SL_Tol 904. Thus, the pre-amp gain is again decreased to maintain an output level within the acceptable range. At time T₄, however, the sound level of the channel drops, forcing a corresponding increase in the pre-amp gain to maintain the desired range. Finally at T₅ the program volume again drops resulting in a near instantaneous increase in pre-amp gain to maintain the desired output level. The net effect of the equalization according to the method of FIG. 8 is to increase the enjoyment of the listening experience for the user. Sharp changes in volume intensity cease to occur, and the STB 100 equalizer system provides a more pleasurable listening experience.

The present invention has been described with reference to certain exemplary embodiments thereof. However, it will be readily apparent to those skilled in the art that it is possible to embody the invention in specific forms other than those of the exemplary embodiments described above. This may be done without departing from the spirit and scope of the invention. The exemplary embodiments are merely illustrative and should not be considered restrictive in any way. The scope of the invention is defined by the appended claims and their equivalents, rather than by the preceding description.

What is claimed is:

1. A method for enabling equalization of channel mean volume levels in a settop box adopted for use in a television system, comprising:
selecting a channel;
reading the desired pre-amp gain from a pre-amp level table for the channel;
setting the pre-amp gain for the channel according to the gain value read from the pre-amp level table.

2. The method according to claim 1, wherein the pre-amp level table is located in a program guide.

3. A method for altering the mean volume level of one or more channels in a settop box adapted for use with a television system, comprising:
selecting a channel;
increasing or decreasing, by means of a suitable user interface, the pre-amp gain control to achieve the desired volume level for the channel; and
storing the new pre-amp gain value for the channel in memory such that the value governs the mean output level of the audio associated with the selected channel whenever the settop box is tuned to that channel.

4. The method according to claim 3, further comprising:
establishing a unique pre-amp gain for each channel receivable by the settop box adapted for use with a television system.

5. The method according to claim 3, further comprising:
establishing a unique pre-amp gain for each channel for each of one or more users

6. A method for equalizing volume levels between at least two channels receivable by a settop box adapted for use with a television system, comprising:
selecting a reference channel;
reading the pre-amp mean output volume level of the reference channel;
storing the mean output level for the reference channel as a reference mean level; and
adjusting the pre-amp gain level for one or more channels receivable by the settop box so that the mean output level of those channels substantially equals the mean reference level.

7. A method for inhibiting all volume changes outside of a specified volume range for at least one channel receivable by a settop box adapted for use with a television system, comprising:
selecting a channel;
reading the pre-amp mean output volume level of the channel;
monitoring the instantaneous pre-amp output level;
adjusting the pre-amp gain control to maintain the pre-amp output level within the specified volume range.

8. The method according to claim 7, further comprising:
storing the specified volume range in the pre-amp gain table.

9. The method according to claim 8, wherein the specified volume range is a unique volume range for each channel receivable by the settop box adapted for use with a television system.

10. The method according to claim 8, wherein the specified volume range is a user defined volume range for each channel receivable by the settop box adapted for use with a television system.

11. The method according to claim 9, wherein the unique volume range for each channel receivable by the settop box adapted for use with a television system is established for one or more users.
